(19) United States
(12) Patent Application Publication
(10) Pub. No.: US 2025/0161721 A1
(43) Pub. Date: May 22, 2025

(54) Powered Air-Purifying Respirator Hood with Exhalation Filter

(71) Applicant: PAPR Force, LLC, St. Louis, MO (US)

(72) Inventor: Jennifer A. Delaney, St. Louis, MO (US)

(21) Appl. No.: 18/510,907

(22) Filed: Nov. 16, 2023

(51) Int. Cl. A62B 7/08; A62B 18/04; A62B 23/02

(52) U.S. Cl. CPC A62B 7/08; A62B 18/04; A62B 23/02

(57) ABSTRACT

A powered air-purifying respirator hood comprising a hood. The hood has a hood body having a chin portion. The chin portion comprises a filter port that is adapted and configured to act as an exit pathway for the exhalation of a user. The chin hood may further comprise a filter housing adapted to releasably receive a filter member. The filter housing is operably and releasably connected to the filter port and the filter member is adapted and configured to filter the exhalation of the user.

### BACKGROUND AND SUMMARY

This disclosure pertains to powered air-purifying respirator hoods. More particularly, the present disclosure pertains to powered air-purifying respirator hoods with a hood body, a visor, a filter port, and a filter member that is removably and operably attachable to the filter port.

As will become evident from the disclosure that follows, the exemplary powered air-purifying respirator hood provides the user safety and comfort in a medical environment. The exemplary powered air-purifying respirator hood has a large interior that allows use without touching the ears or face of the user. Further, the exemplary powered air-purifying respirator hood is designed to allow space in front of a user's face to allow the user to wear glasses, and to allow air flow onto the face. The exemplary powered air-purifying respirator hood also allows space in the hood body to accommodate many hair styles and any head/hair coverings of the user. Additionally, the exemplary powered air-purifying respirator hood is designed to have a filter port that forms an exit pathway for the exhalation of a user that is directed away from a patient being tended to by the user. Further, as may be desired depending upon the application, the filter housing, which may releasably receive a filter member, may be removably and operably attached to the filter port to enable the filtration of the exhalation of a user. Other advantages are set forth in the description that follows.

### BRIEF DESCRIPTION OF THE DRAWINGS

FIG. 1 is a rear perspective view of an exemplary powered air-purifying respirator hood.

FIG. 2 is a left perspective view of the hood of FIG. 1.

FIG. 3 is a perspective view of the filter port of the hood of FIG. 1.

FIG. 4 is a perspective view of the filter housing and filter member of the hood of FIG. 1.

FIG. 5 is a cross sectional view of the filter housing and filter port of the hood of FIG. 1.

### DETAILED DESCRIPTION

The exemplary powered air-purifying respirator hood 100 has a hood body 104. The hood body 104 is formed from a flexible and pliant material that is generally impervious to liquids and atmosphere. Preferably, the hood body 104 is formed from a thermoplastic polyurethane (TPU) coated polyester material. For example, the hood body 104 may be formed from a Du Pont Tychem™ material. Preferably, the hood is not disposable but can be reused and laundered or conventionally cleaned. The hood may also be sterilized depending upon the application.

The hood 100 has a visor 106 extending across a front opening 108 formed in the hood body 104. While the drawings show that the front opening 108 has left and right generally vertical sides and top and bottom generally horizontal sides, the shape of the front opening and the shape of the corresponding visor and sides may vary as desired. The visor 106 extends across the front opening 108 and may be secured to the hood body 104 along the hood body left and right sides and the hood body top and bottom sides in a manner such that the visor and hood body are impervious to liquids and atmosphere. The visor may be transparent and/or tinted for light filtering capability. Preferably, the visor 106 is deflectingly resilient to allow the hood to be folded and/or compressed for packing and storage. The hood also has a rear opening 109 through with which the user may insert his or her face and head in donning the hood. The rear opening may be provided with an elastic border 109a to assist in drawing the rear opening closed around the back of the user's head when the hood is worn.

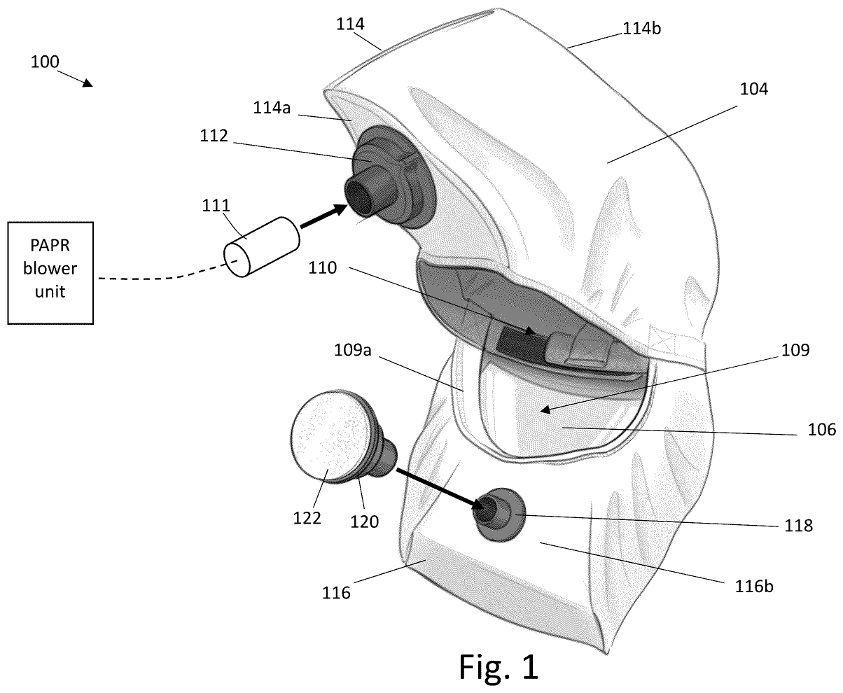

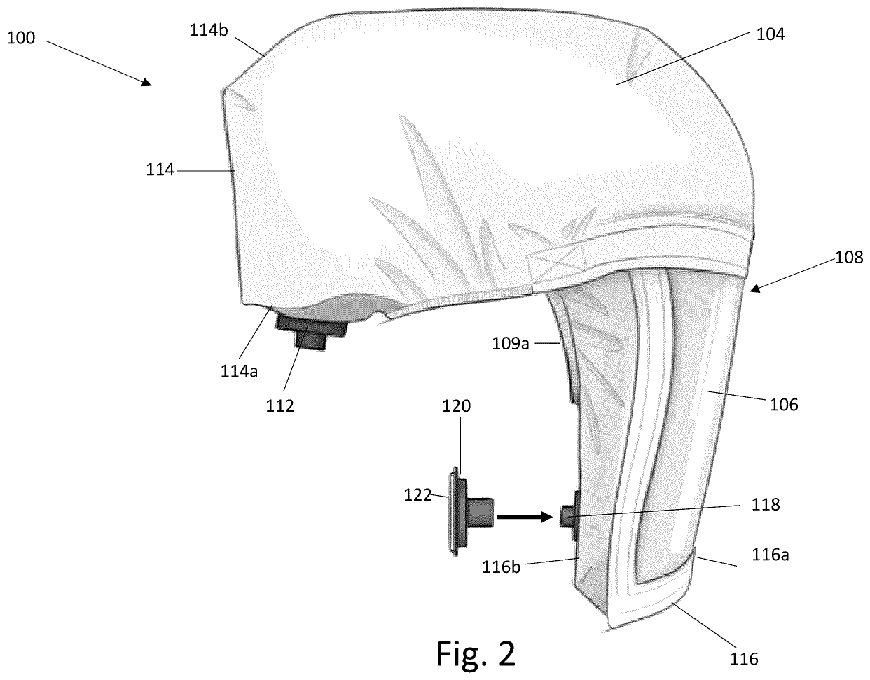

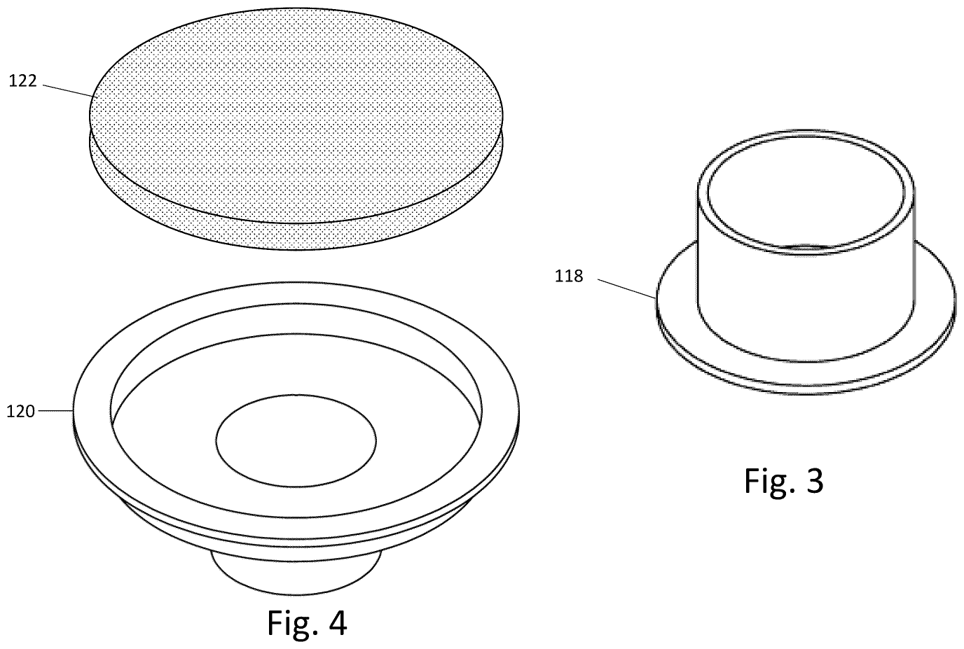

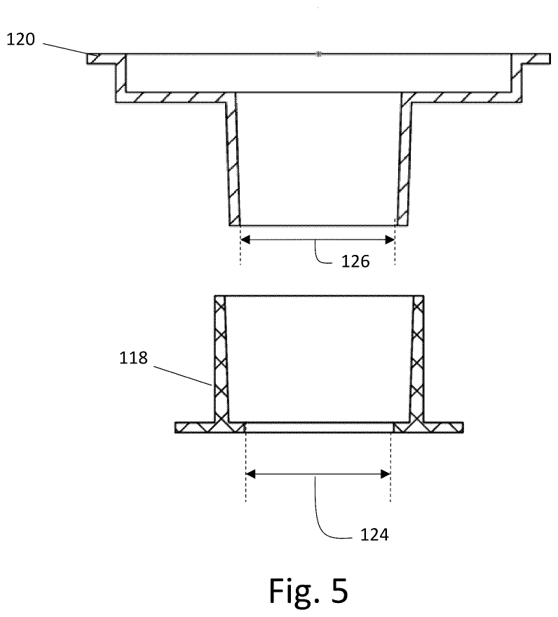

The hood body 104 and visor 106 define an interior 110 of the hood 100 that is sized to accommodate a user's head and provide ample room above the user's head when in use. The hood body 104 may be sized to provide the interior 110 with a volume large enough to hold the user's head and the hair of a user, for instance, in a bun, and prevent the hood body from touching the user's ears and face, when in use. The hood 100 may be adapted and configured to releasably couple with a tube 111 connected with powered air-purifying respirator blower unit (not shown). For example, the hood 100 may have a connection port 112 adapted and configured for receiving the tube 111 from a powered air-purifying respirator unit. The connection port 112 may be configured to connect with the tube 111 in a quick release manner, for instance, a quarter turn connection or a bayonet style connection, or it may have a screw or union type connection. As shown in FIGS. 1-2, the connection port 112 may be located at a rear head portion and underside 114 of the hood 100. The rear head portion 114 generally aligns with the back of the head of a user (not shown) when the hood is worn by such user. The rear head portion may comprise an inferior portion 114a (e.g., the underside surface portion as shown in FIG. 2 when the hood is worn by the user) and an opposite superior portion 114b (e.g., the outward facing top side surface portion as shown in FIG. 2 when the hood is worn by the user). The inferior portion 114a may be the portion of the rear head portion 114 that comprises the connection port 112. Air flow from a blower of the powered air-purifying respirator unit enters the hood interior 110 from the connection port 112 via the tube 111, travels over the top of the user's head in the space between the user's head and the top of the hood body 104, and downward over the user's forehead to the user's nose and mouth and onto the visor 106.

The hood body 104 may have a chin portion 116 located below the visor 106 when the powered air-purifying respirator hood is worn by the user. The chin portion 116 may have an anterior portion 116a and a posterior portion 116b. The anterior portion 116a faces outwardly away from the user when the hood is in use by the user, and the posterior portion 116b faces inwardly toward the user when the hood 100 is in user by the user. The chin portion 116 may comprise a filter port 118 on the exterior of the hood body. Preferably, the filter port 118 is disposed on the posterior portion 116b of the chin portion 116. The filter port 118 may affixed to the hood with an adhesive and/or via welding. The filter port 118 acts as an exit pathway for exhalation from the nose and mouth of the user. Consequently, this creates an airflow pattern Pair that flows from the blower of the powered air-purifying respirator unit through the tube 111, to the hood interior 110 via the connection port 112, travels over the top of the user's head in the space between the user's head and the top of the hood body 104, downward over the user's forehead to the user's nose and mouth and onto the visor 106, where such air is breathed and exhaled by the user, and such exhalation exits through the filter port 118.

The filter housing 120 may be operably and releasably connectable with the filter port 118, and the filter housing 120 may be configured to releasably receive a filter member 122. This permits a user to detach the filter housing 120 from the filter port 118 and hood 100, exchange an expended filter member 122 with a new filter member, and the reattach the filter housing with the new filter member to the filter port and hood, as needed without the need to disassemble the entire mask. The filter member 122 is capable of filtering the exhalation of the user. The filter member 122 is conventional. For instance, the filter member may comprise a multi-layer laminate formed of a spunbond layers of a synthetic polyester filter media disposed between an outer layer (away from the user) and an inner layer (toward the user) of synthetic cellulose filter media. The filter member 122 may be disposable. Preferably, the filter member is not single use. For instance, because the filter member 122 does not directly contact the user's face, it need not be discarded after use of the hood, which allows for reduction of personal protection equipment medical waste in comparison to single use masks. The filter housing 120 may be sized and otherwise configured to allow the filter member 122 to be inserted and retained in the housing, and to be easily removed from the housing. The filter member 122 may be press fit or interference fit with the filter housing 120. In the alternative, a ring or cap (not shown) may be removably detachable with the housing to assist in securing the filter member in the housing and otherwise protecting the filter member when in the housing.

The hood 100 may be kept inflated by the airflow from the powered air-purifying respirator blower unit, and the filter port 118 may be sized such that the airflow out of the filter port without connection to the filter housing 120 and filter member 122 is insufficient to permit the hood 100 to deflate while the powered air-purifying respirator is operating (i.e., so that the airflow leaving the mask is less than or equal to the airflow entering the mask). For example, the filter port 118 may have its smallest internal diameter 124 between 29/32 inch and 31/32 inch (that is, the diameter of the shoulder formed on the interior of the filter port). Thus, the powered air-purifying respirator may be used with a filter housing 120 and/or filter member 122 should one be available, or without the filter housing and/or filter member if not available, as the case may be. Additionally, the filter housing 120 and filter member 122 are sized similarly and configured so that the hood 100 does not deflate while the powered air-purifying respirator is operating. For instance, the connection region of the filter housing may have an internal diameter 126 between 31/32 inches and 1 1/32 inches. The connection region of the filter housing and the filter port may have matching tapered surfaces to assist in press fitting the filter housing into the filter port.

Both the filter port 118, and the filter housing 120 and member 122, are positioned on the chin area 116 such that the exhalation of the user is directed away from the visor and, consequently, away from any patient that the user may be facing. Preferably, the filter housing 120 and filter member 122 project posteriorly from the filter port 118. This arrangement minimizes the risk that the patient is exposed to contagious pathogens from the user of the hood. For instance, as shown in the drawings, the filter port 118, and the filter housing 120 and member 122 are provided on the posterior face of the chin area of the hood (facing the user's chest/throat area when in use).

As various modifications could be made in the construction herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims hereto and their equivalents.

What is claimed is:

1. A powered air-purifying respirator hood comprising:
a hood with a hood body, the hood body having a chin portion, the chin portion having an anterior portion and a posterior portion, the anterior portion facing away from the user when the hood is in use by a user, the posterior portion facing toward the user when the hood is in use by a user, and further comprising a filter port disposed on the posterior portion of the chin portion, the filter port being adapted and configured to act as an exit pathway for an exhalation of the user.

2. The powered air-purifying respirator hood of claim 1, further comprising a filter housing, the filter housing being operably and releasably connected to the filter port.

3. The powered air-purifying respirator hood of claim 2, further comprising a filter member, the filter member being releasably receivable in the filter housing, the filter member being and adapted and configured to filter the exhalation of the user.

4. The powered air-purifying respirator hood of claim 2, wherein the filter housing projects posteriorly from the filter port.

5. The powered air-purifying respirator hood of claim 1, wherein the hood body further comprises a rear head portion, the rear head portion having an inferior portion and a superior portion, the inferior portion comprising a connection port configured to be operably connected to a powered air-purifying blower unit via a tube.

6. The powered air-purifying respirator hood of claim 1 wherein the filter port has an inner diameter between 15/16 of an inch and 1 inch.
